(19) United States
(12) Patent Application Publication
(10) Pub. No.: US 2025/0075696 A1
(43) Pub. Date: Mar. 6, 2025

(54) COMPRESSOR FIXING DEVICE

(71) Applicant: SAMSUNG ELECTRONICS CO., LTD., Suwon-si (KR)

(72) Inventors: Sung HAN, Suwon-si (KR); Kwanwoo HONG, Suwon-si (KR); Jeonghoon KANG, Suwon-si (KR); Minsung KIM, Suwon-si (KR); Ho CHOI, Suwon-si (KR)

(73) Assignee: SAMSUNG ELECTRONICS CO., LTD., Suwon-si (KR)

(21) Appl. No.: 18/949,547

(22) Filed: Nov. 15, 2024

Related U.S. Application Data
(63) Continuation of application No. PCT/KR2023/005511, filed on Apr. 21, 2023.

(30) Foreign Application Priority Data
May 26, 2022 (KR) 10-2022-0064958

(51) Int. Cl. F04B 53/22; A47L 15/42; F04B 53/00

(52) U.S. Cl. CPC F04B 53/22; F04B 53/003; A47L 15/42

(57) ABSTRACT

A compressor fixing device is provided. The compressor fixing device includes a base, a protruding member protruding from an upper surface of the base, a buffering member disposed to be penetrated by the protruding member, a support panel disposed on an upper portion of the base to support the compressor, and secured to the buffering member; and a clip member configured to fix the protruding member and the buffering member, and the clip member includes a first region in which a fixing groove into which the protruding member is inserted is formed, and which includes a lower surface in contact with the buffering member, a second region disposed to face the first region, in which a fixing hole through which a top of the protruding member is penetrated is formed, and a third region configured to connect the first region and the second region.

### CROSS-REFERENCE TO RELATED APPLICATIONS

This application is a continuation of International Application No. PCT/KR2023/005511, filed Apr. 21, 2023, and claims foreign priority to Korean Application No. 10-2022-0064958, filed May 26, 2022, and which are incorporated herein by reference in their entireties.

### TECHNICAL FIELD

The present disclosure relates to a compressor fixing device, and more particularly, to a compressor fixing device capable of fixing a compressor through a simple structure and reducing vibration and noise generated during operation of the compressor.

### BACKGROUND ART

Compressors are configured to compress and discharge refrigerant at high temperature and pressure, and are found in various home appliances such as washers, dryers, refrigerators, and clothes managers. Compressors generate noise and vibration when they operate, so when they are fixed inside home appliances, they are designed to reduce noise and vibration.

In the past, a screw fastening structure using bolts and nuts was used to fix a compressor inside a home appliance. However, in the case of a screw fastening structure, in order to prevent the compressor from interfering with a screw fastening path, it was necessary to place the screw fastening position at a certain distance away from the compressor, and it was necessary to ensure that the volume of the inside of the home appliance is large enough to accommodate a compressor fixing structure. Accordingly, it was difficult to install a compressor in a small home appliance with a relatively small volume.

### DETAILED DESCRIPTION OF THE DISCLOSURE

### Technical Tasks

The present disclosure is to address the above problem by providing a compressor fixing device capable of simplifying a fixing structure of a compressor using a clip structure.

### Technical Solution

A compressor fixing device according to an embodiment may include a base, a protruding member protruding from an upper surface of the base, a buffering member, a support panel having a through hole, and a clip member including a first region in which a fixing groove is formed, a second region facing the first region and in which a fixing hole is formed, and a third region connecting the first region and the second region, wherein the base, the protruding member, the buffering member, the support panel, and the clip member may be configured to be assembled together to fix a compressor to a product and so that, when assembled together and fixing the compressor to the product, the support panel is connected to the compressor, the protruding member penetrates the buffering member so as to be surrounded by the buffering member, a top of the protruding member and a top of the buffering member penetrate the through hole so that the buffering member is secured to the through hole, the top of the protruding member is inserted into the fixing groove and penetrates the fixing hole, and a lower surface of the first region is in contact with the buffering member, and the base is secured to the product, so that the compressor is thereby fixed to the product.

When the base, the protruding member, the buffering member, the support panel, and the clip member are assembled together, fixing groove may be recessed in a horizontal direction with the support panel.

The third region may be connected to one end of the first region and one end of the second region, and the clip member may have a U-shape in which the first region, the third region and the second region are sequentially connected.

The second region may has a first end connected to the third region, and a second end that is opposite to the first end and that is bent away from the first region.

The top of the protruding member may have a cross-sectional region that decreases in an upward direction at a position corresponding to the second end of the second region.

The protruding member may have a concave portion that is recessed inwardly, and, when the base, the protruding member, the buffering member, the support panel, and the clip member are assembled together, the concave portion may be fitted into the fixing groove.

The buffering member may have a cylindrical shape and a hollow through the cylindrical shape, and the protruding member may penetrate the buffering member through the hollow.

When the base, the protruding member, the buffering member, the support panel, and the clip member are assembled together, top of the protruding member may protrude past an upper portion of the buffering member.

The buffering member may be made of an elastic material.

The buffering member may include a recess formed along a perimeter of the buffering member and, when the base, the protruding member, the buffering member, the support panel, and the clip member are assembled together, the recess of the buffering member may be secured to the through hole.

A dishwasher according to an embodiment may include a main body, a compressor housed in the main body, and a compressor fixing device. The compressor fixing device may include a base secured to the main body or a frame of the dishwasher, a buffering member, a protruding member protruding from an upper surface of the base and penetrating the buffering member so as to be surrounded by the buffering member, a support panel connected to the compressor and having a through hole, and a clip member including a first region in which a fixing groove is formed, a second region facing the first region and in which a fixing hole is formed, and a third region connecting the first region and the second region, wherein a top of the protruding member and a top of the buffering member may penetrate the through hole so that the buffering member is secured to the through hole, and the top of the protruding member may be inserted into the fixing groove and penetrate the fixing hole, and a lower surface of the first region may be in contact with the buffering member.

The fixing groove may be recessed in a horizontal direction with the support panel.

The third region may be connected to an end of the first region and an end of the second region, and the clip member may have a U-shape in which the first region, the third region and the second region are sequentially connected.

The second region may have a first end connected to the third region, and a second end that is opposite to the first end and is bent away from the first region.

The top of the protruding member may have a cross-sectional region that decreases in an upward direction at a position corresponding to the second end of the second region.

### BRIEF DESCRIPTION OF DRAWINGS

FIG. 1 is a perspective view illustrating a compressor fixing device according to an embodiment;

FIG. 2 is an exploded perspective view provided to explain configuration of a compressor fixing device according to an embodiment;

FIG. 3 is a view provided to explain a structure in which a clip member is fastened to a protruding member according to an embodiment;

FIG. 4 is a cross-sectional view cut along IV-IV of FIG. 1;

FIG. 5 is a view illustrating a side surface of a compressor fixing device according to an embodiment; and

FIG. 6 is a view illustrating an example of a compressor fixing device with a reduced side length compared to FIG. 5.

### DETAILED DESCRIPTION OF EMBODIMENTS

The embodiments described below are shown as examples to aid understanding of the present disclosure, and it should be understood that the present disclosure may be practiced in various modifications that are different from the embodiments described herein. However, in describing the present disclosure below, if it is determined that detailed descriptions of related known functions or components may unnecessarily obscure the gist of the present disclosure, the detailed descriptions and specific illustrations will be omitted. In addition, in order to aid understanding of the disclosure, the attached drawings are not drawn to actual scale, and the dimensions of some components may be exaggerated.

General terms are selected in the specification and the claims of the present disclosure in consideration of the function of the present disclosure. However, these terms may vary depending on the intent of those skilled in the art, legal or technical interpretations, and the emergence of new technologies, or the like. In addition, some terms are arbitrarily selected by the applicant. These terms may be interpreted as defined in this specification, and in the absence of specific definitions, they may be interpreted based on the overall content of this specification and common technical knowledge in the relevant technical field.

In the description of the present disclosure, the order of each step should be understood as non-limiting, unless the earlier step must logically and temporally precede the later step. In other words, except for the above cases, even if the process described as a subsequent step is performed before the process described as a preceding step, the nature of disclosure is not affected, and the scope of rights must also be defined regardless of the order of the steps.

In the disclosure, an expression “have”, “may have”, “include”, “may include” or the like, indicates the existence of a corresponding feature (for example, a numerical value, a function, an operation or a component such as a part), and does not exclude the existence of an additional feature.

Terms such as first, second, etc. may be used to describe various components, but the components should not be limited by such terms. The above terms may be used only for the purpose of distinguishing one component from another. For example, a first component may be referred to as a second component, and similarly, the second component may be referred to as the first component without departing from the scope of the present disclosure.

In addition, terms such as ‘front’, ‘rear’, ‘top’, ‘bottom’, ‘side’, ‘left’, ‘right’, ‘upper’, and ‘lower’ used in the present disclosure are defined with reference to the drawings, and are not intended to limit the shape and location of each component.

Further, this specification describes components necessary for the description of each embodiment of the present disclosure, and it is not necessarily limited thereto. Accordingly, some components may be changed or omitted, and other components may be added. Additionally, the components may be distributed and disposed on different independent devices.

Furthermore, while embodiments of the present disclosure will be described in detail below with reference to the accompanying drawings and the descriptions thereof, but the present disclosure is not limited thereto.

Hereinafter, the present disclosure will be described in greater detail with reference to the accompanying drawings.

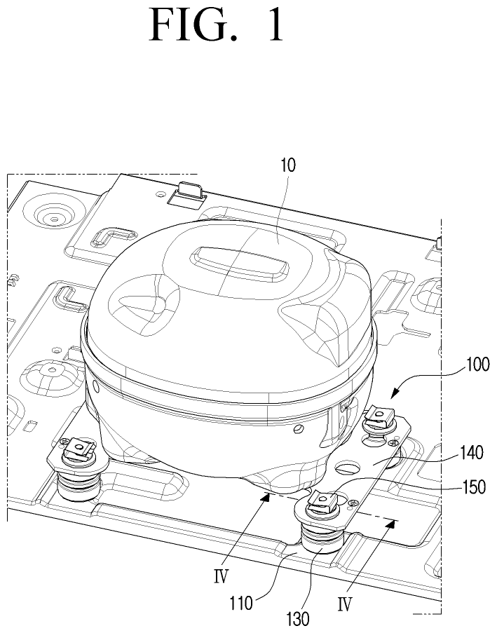

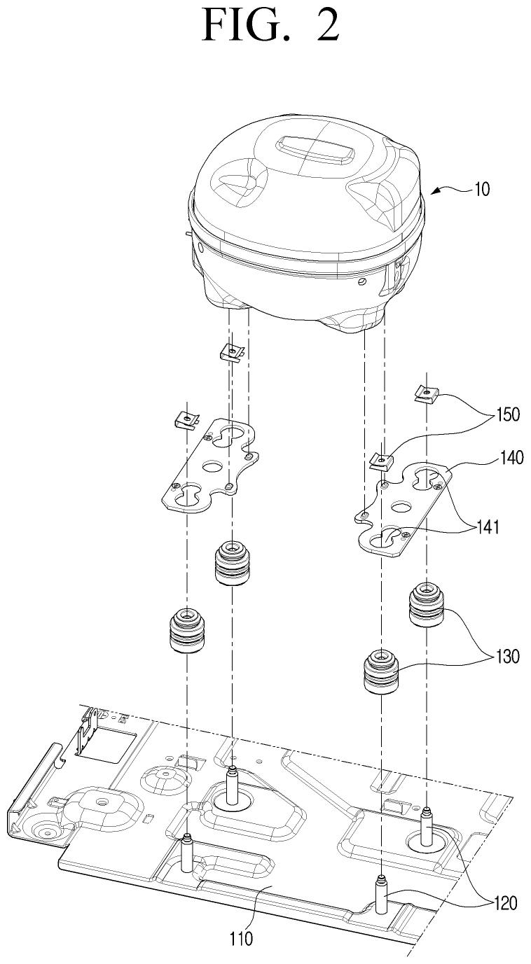

FIG. 1 is a perspective view illustrating a compressor fixing device according to an embodiment, and FIG. 2 is an exploded perspective view provided to explain configuration of a compressor fixing device according to an embodiment.

A compressor 10 is configured to compress and discharge refrigerant at a high temperature and pressure, and is found in a variety of home appliances, such as washers, dryers, refrigerators, clothes managers, and the like.

Meanwhile, in the case of home appliances having a relatively small volume, such as dishwashers, it is difficult to provide a compressor that occupies a large space and generates noise and vibration. Hereinafter, according to an embodiment, a compressor fixing device 100 that simplifies the fixing structure of a compressor so as to be applicable to a home appliance having a small internal space, such as a dishwasher, will be described.

Referring to FIGS. 1 and 2, the compressor fixing device 100 according to an embodiment, includes a base 110, a protruding member 120, a buffering member 130, a support panel 140, and a clip member 150.

The compressor 10 may be assembled to be secured to the base 110. The base 110 may be secured to the interior of a product including the compressor 10, or may be integrally formed with the frame of the product.

The protruding member 120 is secured to the base 110, and may be arranged to protrude from the top surface of the base 110.

The buffering member 130 may be formed of an elastic material for absorbing vibrations generated by the compressor 10, and may be disposed between the compressor 10 and the base 110 to absorb shocks transmitted from the compressor 10 to the base 110. The buffering member 130 may have a hollow and cylindrical shape, and may be fitted to surround the protruding member 120. In other words, the protruding member 120 may penetrate the buffering member 130 through the hollow formed inside the buffering member 130.

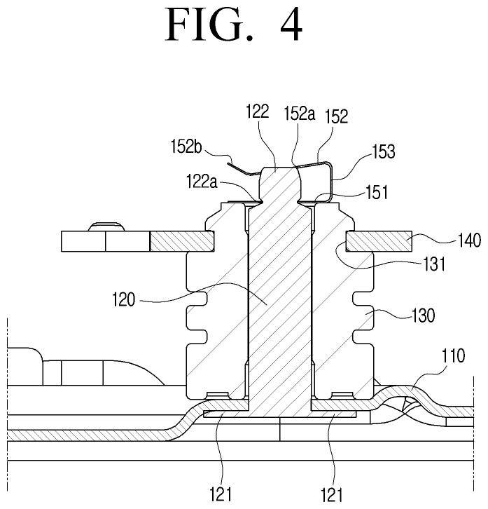

The support panel 140 is connected to the compressor 10 and is configured to support the compressor 10. The support panel 140 may be secured to the buffering member 130 and disposed on top of the base 110. The support panel 140 may be secured to the buffering member 130 via a coupling between the buffering member 130 and a through hole 141 formed through the support panel. A detailed construction in this regard will be described later with reference to FIG. 4.

The clip member 150 is configured to secure the protruding member 120 and the buffering member 130, and may be formed to have a U-shaped clip. The clip member 150 may fix the protruding member 120 and the buffering member 130 by coupling to the upper end of the protruding member 120 that protrudes upward through the buffering member 130.

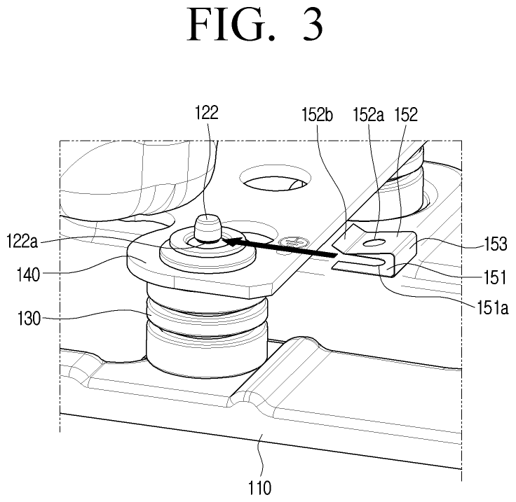

Hereinafter, the fastening structure of the clip member 150 will be described in detail with reference to FIGS. 3 and 4.

FIG. 3 is a view provided to explain a structure in which the clip member 150 and the protruding member 120 are fastened to each other according to an embodiment, and FIG. 4 is a cross-sectional view cut along IV-IV of FIG. 1.

According to an embodiment, to assemble the compressor fixing device 100, the buffering member 130 may first be inserted into the protruding member 120 coupled to the base 110, and the support panel 140 connected to the compressor 10 may be seated on the buffering member 130.

Referring to FIG. 4, the protruding member 120 may be inserted from the bottom to the top through a hole formed in the base 110 and protrude to the upper portion of the base 110, and may be coupled to the base through a flange 121 formed at the bottom of the protruding member 120 to ensure that the region protruding to the upper portion of the base 110 remains constant. However, the shape of the protruding member 120 is not limited thereto, and the protruding member 120 may be implemented to be integrally formed with the base 110.

Referring to FIGS. 3 and 4, the buffering member 130 may have a hollow and cylindrical shape, the protruding member 120 may penetrate the buffering member 130 through the hollow of the buffering member 130, and a top 122 of the protruding member 120 may protrude to the upper portion of the buffering member 130.

The buffering member 130 may be made of an elastic material, such as rubber. The buffering member 130 may include a recess 131 formed along the perimeter, and the support panel 140 may be secured to the buffering member 130 through a through hole 141 formed at a location where the support panel 140 is coupled to the buffering member 130. Specifically, a region of the recess 131 of the buffering member 130 may be recessed into and secured to the through hole 141 of the support panel 140.

In addition, the clip member 150 may be fastened to the top 122 of the protruding member 120 that projects to the upper portion of the buffering member 130 to secure the protruding member 120 and the buffering member 130.

In this case, the clip member 150 may be moved in a horizontal direction to be coupled to the top 122 of the protruding member 120. Conventionally, in order to secure the base 110, the buffering member 130, and the support panel 140, screws were fastened in a vertical direction penetrating the buffer member 130, and it is necessary to position the screws at least a certain distance away from the compressor to avoid interference with the compressor when the screws were fastened.

Meanwhile, according to an embodiment, the clip member 150 may be moved in a horizontal direction and fastened to the protruding member 120, so that the fastening position can be closer to the compressor, thereby reducing the overall volume of the compressor assembly structure.

Referring to FIG. 3, the clip member 150 may include a first region 151, a second region 152, and a third region 153. The first region 151 and the second region 152 are disposed to face each other horizontally and are connected by the third region 153, and the clip member 150 may have a bent shape at the boundary of each region. In other words, the third region 153 may be connected to each of one end of the first region 151 and one end of the second region 152, and the clip member 150 may have a U-shape in which the first region 151, the third region 153, and the second region 152 are connected sequentially.

A fixing groove 151a for coupling to the protruding member may be formed on the first region 151. The fixing groove 151a may be formed to recess in a direction parallel to the support panel 140, toward the third region 153 from the other end that is opposite to one end of the first region 151 connected to the third region 153.

The protruding member 120 may include the top 122 that projects to the upper portion of the buffering member 130, and a concave portion 122a that is recessed inwardly may be formed at the location that protrudes to the upper portion of the buffering member 130. The concave portion 122a may be fitted into the fixing groove 151a of the clip member 150 such that the clip member 150 and the protruding member 120 are secured.

When the fixing grooves 151a of the clip member 150 is fitted into the concave portion 122a of the protruding member 120, the bottom surface of the first region 151 of the clip member 150 may contact the buffering member 130 and be secured by frictional force against the buffering member 130.

A fixing hole 152a that is secured to the top 122 of the protruding member 120 may be formed on the second region 152, and an upwardly bent end 152b may be formed on the other end that is opposite to the end where the second region 152 is connected to the third region 153.

The top 122 of the protruding member 120 may have a shape in which the cross-sectional area decreases in an upward direction at a position corresponding to the bent end 152b of the second region 152.

Accordingly, when the clip member 150 is moved in a horizontal direction and fastened to the protruding member 120, the bent end 152b of the second region 152 is pushed against the top 122 of the protruding member 120 and elastically deformed to bend upwardly, and when the fixing groove 151a moves to a position where it is seated in the concave portion 122a, the top 122 of the protruding member 120 is seated inside the fixing hole 152a to reliably support the coupling between the protruding member 120 and the clip member 150.

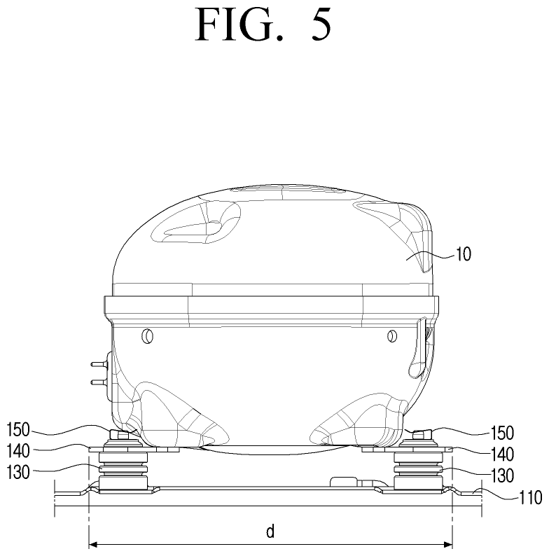

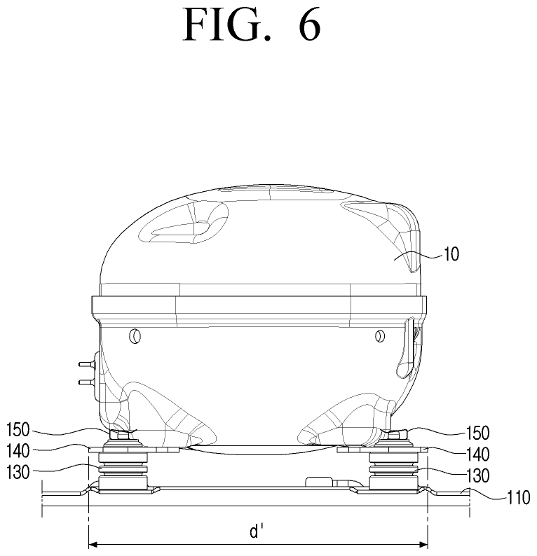

FIG. 5 is a view illustrating a side surface of a compressor fixing device according to an embodiment, and FIG. 6 is a view illustrating an example of a compressor fixing device with a reduced side length compared to FIG. 5.

Referring to FIGS. 5 and 6, the side length of the compressor fixing device can be minimized by changing the design structure of the compressor and the compressor fixing device. Since the clip member 150 according to an embodiment can move in a horizontal direction to perform a fastening operation, the fastening position may be brought close to the compressor 10 to the extent that it does not interfere with the compressor 10 in the horizontal direction. Accordingly, the side length (d) of the compressor fixing device shown in FIG. 5 can be minimized to the side length (d′) of the compressor fixing device shown in FIG. 6 through a design change, and the volume occupied by the compressor fixing device can be reduced to a minimum.

Although preferred embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. A compressor fixing device, comprising:
a base;
a protruding member protruding from an upper surface of the base;
a buffering member;
a support panel having a through hole; and
a clip member including:
a first region in which a fixing groove is formed,
a second region facing the first region and in which a fixing hole is formed, and
a third region connecting the first region and the second region,
wherein the base, the protruding member, the buffering member, the support panel, and the clip member are configured to be assembled together to fix a compressor to a product and so that, when assembled together and fixing the compressor to the product,
the support panel is connected to the compressor,
the protruding member penetrates the buffering member so as to be surrounded by the buffering member,
a top of the protruding member and a top of the buffering member penetrate the through hole so that the buffering member is secured to the through hole,
the top of the protruding member is inserted into the fixing groove and penetrates the fixing hole, and a lower surface of the first region is in contact with the buffering member, and
the base is secured to the product,
so that the compressor is thereby fixed to the product.

2. The compressor fixing device as claimed in claim 1, wherein, when the base, the protruding member, the buffering member, the support panel, and the clip member are assembled together, the fixing groove is recessed in a horizontal direction with the support panel.

3. The compressor fixing device as claimed in claim 1, wherein
the third region is connected to one end of the first region and one end of the second region, and
the clip member has a U-shape in which the first region, the third region and the second region are sequentially connected.

4. The compressor fixing device as claimed in claim 3, wherein the second region has a first end connected to the third region, and a second end that is opposite to the first end and is bent away from the first region.

5. The compressor fixing device as claimed in claim 4, wherein the top of the protruding member has a cross-sectional region that decreases in an upward direction at a position corresponding to the second end of the second region.

6. The compressor fixing device as claimed in claim 1, wherein
the protruding member has a concave portion that is recessed inwardly, and,
when the base, the protruding member, the buffering member, the support panel, and the clip member are assembled together, the concave portion is fitted into the fixing groove.

7. The compressor fixing device as claimed in claim 1, wherein
the buffering member has a cylindrical shape and has a hollow through the cylindrical shape, and
the protruding member penetrates the buffering member through the hollow.

8. The compressor fixing device as claimed in claim 7, wherein, when the base, the protruding member, the buffering member, the support panel, and the clip member are assembled together, the top of the protruding member protrudes past an upper portion of the buffering member.

9. The compressor fixing device as claimed in claim 1, wherein the buffering member is made of an elastic material.

10. The compressor fixing device as claimed in claim 9, wherein
the buffering member includes a recess formed along a perimeter of the buffering member, and
when the base, the protruding member, the buffering member, the support panel, and the clip member are assembled together, the recess of the buffering member is secured to the through hole.

11. A dishwasher, comprising:
a main body;
a compressor housed in the main body; and
a compressor fixing device including:
a base secured to the main body or a frame of the dishwasher,
a buffering member,
a protruding member protruding from an upper surface of the base and penetrating the buffering member so as to be surrounded by the buffering member,
a support panel connected to the compressor and having a through hole, and
a clip member including
a first region in which a fixing groove is formed,
a second region facing the first region and in which a fixing hole is formed, and
a third region connecting the first region and the second region, wherein
a top of the protruding member and a top of the buffering member penetrate the through hole so that the buffering member is secured to the through hole, and
the top of the protruding member is inserted into the fixing groove and penetrates the fixing hole, and a lower surface of the first region is in contact with the buffering member.

12. The dishwasher as claimed in claim 11, wherein the fixing groove is recessed in a horizontal direction with the support panel.

13. The dishwasher as claimed in claim 11, wherein
the third region is connected to an end of the first region and an end of the second region, and
the clip member has a U-shape in which the first region, the third region and the second region are sequentially connected.

14. The dishwasher as claimed in claim 13, wherein the second region has a first end connected to the third region, and a second end that is opposite to the first end and is bent away from the first region.

15. The dishwasher as claimed in claim 14, wherein the top of the protruding member has a cross-sectional region that decreases in an upward direction at a position corresponding to the second end of the second region.
